(19) United States
(12) Patent Application Publication
(10) Pub. No.: US 2005/0220941 A1
(43) Pub. Date: Oct. 6, 2005

(54) Packaging apparatus

(76) Inventor: Bret Selby, Bakersfield, CA (US)

Correspondence Address: James M. Duncan;Klein, DeNatale, Goldner, Cooper,, Rosenlieb, & Kimball, LLP, P.O. Box 11172, Bakersfield, CA, 93389-1172, US

(21) Appl. No.: 10/814,942

(22) Filed: Mar. 30, 2004

(51) Int. Cl. C12C 1/027

(52) U.S. Cl. 426/106

(57) ABSTRACT

A packaging apparatus having two compartments which, before use, are pivotally attached to one another. The first compartment holds a food product, such as sunflower seeds or pistachios. The second compartment, originally attached to the first compartment, is separated from the first compartment by the user. The first compartment containing the food product is opened. The second compartment is then opened up to form a disposal cup which the user may use to dispose of the waste from the food product, such as shells, hulls, seeds, pits, etc. The bottom of the disposal cup may be folded into a flat base, allowing the user to conveniently set the disposal cup down.

### BACKGROUND OF THE INVENTION

The present invention generally relates to food packaging and more specifically to packages for seeds, nuts, dried fruits and other food products having shells, hulls, seeds or pits, in which a designated portion of the packaging may be utilized for catching, retaining and disposing of the waste materials from the food product.

Sunflower seeds, pistachios, and assorted nuts and dried fruits are enjoyed by many as convenient snack foods. Many times these food products are packaged and sold in the shell, or without other waste materials being removed from the food product. However, the shells, hulls, seeds or pits of these food products are normally not consumed, and disposal of the waste materials can be problematic. For example, it is not uncommon to see baseball players awaiting a turn at bat sitting on their bench eating sunflower seeds and spitting out the shells onto the ground around them, resulting in an unsightly mess. The disclosed invention provides means for retaining and disposing of shells, hulls, seeds, pits, or other food waste products.

### SUMMARY OF THE INVENTION

The present invention provides a solution to the above-identified need. In general terms, the invention is a package having two compartments, which are, before use, pivotally attached to one another. The first compartment holds the food product. The second compartment, originally attached to the first compartment, is separated from the first compartment by the user. The first compartment containing the food product is opened. The second compartment is then opened up to form a disposal cup which the user may use to dispose of the shells, hulls, etc. The bottom of the disposal cup may be folded into a flat base, allowing the user to conveniently set the disposal cup down.

More specifically, the present invention is directed to a food package apparatus containing a food product in a first section of the apparatus and a second section adapted to receive and retain waste from the food product. The food package apparatus comprises a food product containing section having a first front panel and an opposite facing first back panel. The first front panel and the first back panel are each bordered by a first peripheral edge, and are attached together along the first peripheral edge. The food product containing section has a first compartment defined by the first front panel, the first back panel and the first peripheral edge. A portion of the first peripheral edge defines a top of the food containing section. A food product is disposed in the first compartment. The apparatus further comprises a waste collection section. The waste collection section comprises a second front panel and an opposite facing second back panel. The second front panel and the second back panel are each bordered by a second peripheral edge, and are attached together along the second peripheral edge. The waste collection section has a second compartment defined by the second front panel, the second back panel and the second peripheral edge, a portion of the second peripheral edge defining a top of the waste collection section. The top of the food product containing section is hingedly attached to the top of the waste collection section by a perforated attachment means, allowing the food product containing section to be detached from the waste collection section. The top of the food product section has a first access means allowing access to the first compartment and the top of the waste collection section has a second access means allowing access to the second compartment. The first access means and second access means are operational after the food containing section has been detached from the waste collection section.

### BRIEF DESCRIPTION OF THE DRAWINGS

FIG. 1 is a prospective view of an embodiment of the disclosed packaging apparatus.

FIG. 2A is a plan view of front of an embodiment of the disclosed packaging apparatus in an unfolded position.

FIG. 2B is a plan view of the back of the disclosed packaging apparatus shown in FIG. 2A.

FIG. 3A is a perspective view of the food product containing section of an embodiment of the disclosed packaging apparatus.

FIG. 3B is a perspective view of the waste collection section of an embodiment of the disclosed packaging apparatus.

FIG. 4 shows how the triangular flaps of an embodiment of the bottom of the waste collection section may be folded.

FIG. 5 the rectangular base of an embodiment of the waste collection section.

FIG. 6 shows a perspective view of an embodiment of the waste collection section, after the bottom has been collapsed but before the triangular flaps are folded into the base.

FIG. 7 shows a perspective view of an embodiment of the waste collection section, after the bottom has been collapsed and the triangular flaps folded.

### DETAILED DESCRIPTION OF THE EMBODIMENTS

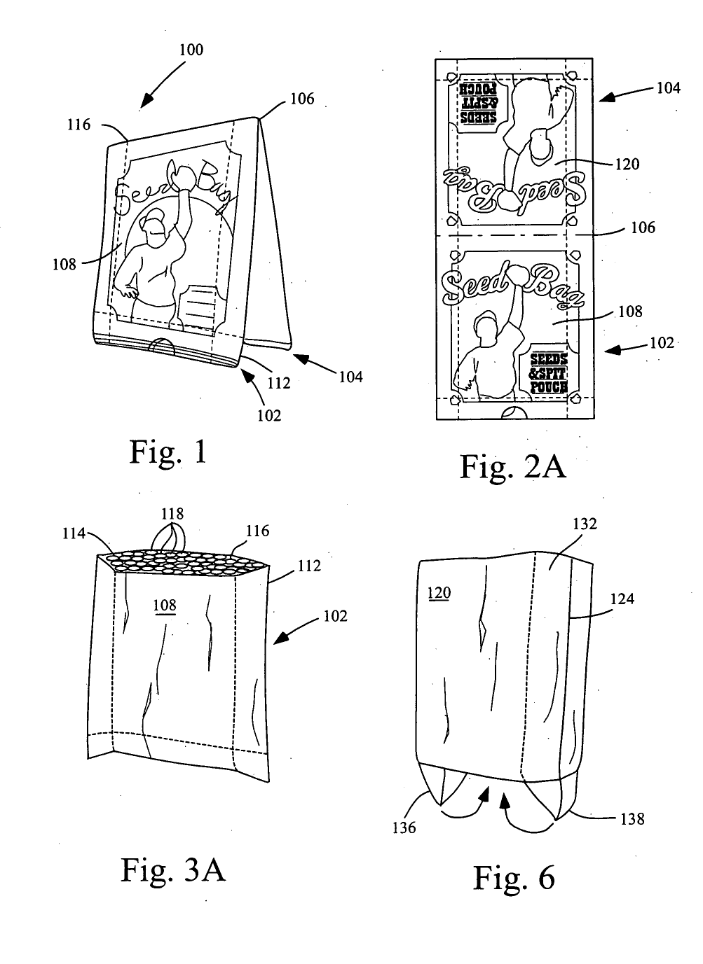

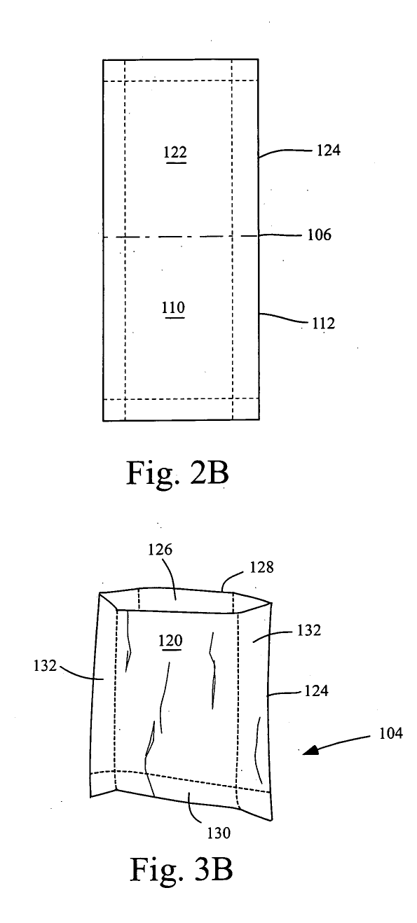

Referring now specifically to the drawings, FIG. 1 shows a perspective view of one embodiment of the disclosed invention. As seen from FIG. 1, the packaging apparatus 100 comprises a food product containing section 102 which is hingedly attached to a waste collection section 104 by perforated attachment means 106. As shown in FIGS. 1 and 2A, the exterior surface of the packaging apparatus may be decorated according to the desired market. For example, the packaging apparatus shown in FIGS. 1 and 2A is decorated with a baseball theme, although the functionality of the device is not determined by the decoration. FIG. 2B, which shows the back of the embodiment shown in FIG. 2A, may likewise be decorated, but is shown blank in FIG. 2B to distinguish it from FIG. 2A.

The food product containing section 102 comprises a first front panel 108 and an opposite facing first back panel 110. The first front panel 108 and the first back panel 110 are each bordered by a first peripheral edge 112. The first front panel 108 and the first back panel 110 are attached together along the first peripheral edge 112.

The food product containing section 102 has a first compartment 114 defined by the first front panel 108, the first back panel 110 and the first peripheral edge 112. A portion of the first peripheral edge 112 defines a top 116 of the food containing section 102. A food product 118 is disposed in the first compartment 114. While the variety of food product which may be contained in the first compartment 114 section is practically unlimited, the disclosed packaging apparatus is particularly useful for sunflower seeds, pistachios, and a large variety of nuts or dried fruits containing seeds or pits. The packaging apparatus may be constructed of food grade packaging paper. The paper may be treated with a wax coating on one or both sides of the paper to enhance the sealing capabilities of the paper.

The waste collection section 104 comprises a second front panel 120 and an opposite facing second back panel 122. The second front panel 120 and the second back panel 122 are each bordered by a second peripheral edge 124. The second front panel 120 and the second back panel 122 are attached together along the second peripheral edge 124. The waste collection section 104 has a second compartment 126 defined by the second front panel 120, the second back panel 122 and the second peripheral edge 124. A portion of the second peripheral edge 124 defines a top 128 of the waste collection section.

Although the figures show the different panels of the apparatus to be rectangular in shape, it is to be appreciated that a variety of different shapes may be used. However, for appearance and manufacturing convenience, the same shape will generally be used for the first front panel 108, the first back panel 110, the second front panel 120 and the second back panel 122. The apparatus may be sized such that it conveniently fits in a shirt or hip pocket for easy transport and accessibility.

As shown in FIG. 1, perforated attachment means 106 hingedly connect the top 116 of the food product containing section 102 to the top 128 of the waste collection section 104. The perforations allow the food product containing section 102 to be easily detached from the waste collection section 104 by simply tearing the package along the perforations. When the food product containing section 102 is separated from the waste collection section 104, the user has access through the top 116 to the food product 118 contained in the first compartment 114. Likewise, upon separating the two sections, the user has access to the second compartment 126, which is easily expanded into a cup-like container for disposal of any waste from the food product.

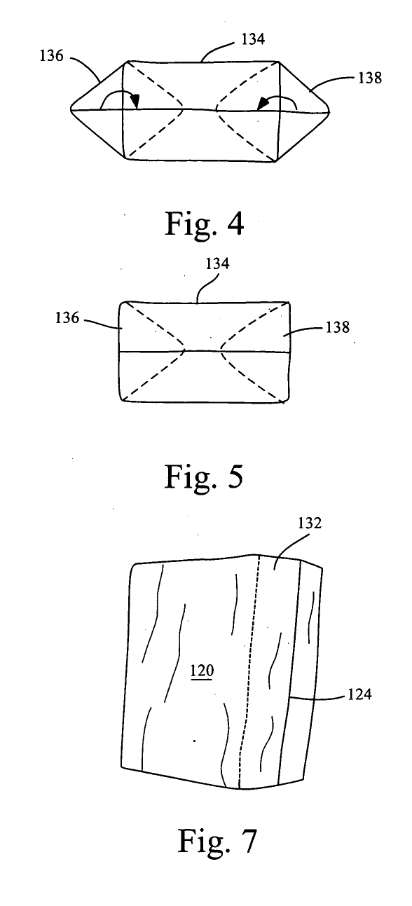

The waste collection section 104 may have a collapsible bottom 130, which is oppositely facing the top 128. Waste collection section 104 also has opposite facing sides 132. As shown in FIG. 3B, collapsible bottom 130 may be urged upwardly while simultaneously unfolding opposite facing sides 132 along second peripheral edge 124, causing waste collection section 104 to form a generally cup-like device. As shown in FIG. 4 and FIG. 6, upon being manipulated in this manner, the collapsible bottom 130 forms a generally rectangular base 134, a first triangular flap 136 and a second triangular flap 138. As shown in FIG. 5 and FIG. 6, the first triangular flap 136 and the second triangular flap 138 may be folded against the rectangular base 134. The first triangular flap 136 and the second triangular flap 138 may comprise adhesive means for retaining the first triangular flap and the second triangular flap to the base 134. The adhesive means may comprise those known in the art, such as a gum adhesive, tape, or stickers. FIG. 7 shows what one embodiment of the waste collection section 104 after it has been manipulated as described above.

A method of using the described packaging apparatus may be described as follows. The user flattens out the apparatus, and separates the food product containing section 102 from the waste collection section 104 by tearing the perforated attachment means 106. Once the two sections are separated, the user may gain access to the food product 118 in the first compartment 114 by separating the first front panel 108 and an opposite facing first back panel 110 at the top 116. Likewise, the user takes the waste collection section 104, and gains access to the second compartment 126 by separating the second front panel 120 from the second back panel 122 at the top 128. The user may press their fingers against collapsible bottom 130, urging upwardly while simultaneously squeezing in opposite facing sides 132 along second peripheral edge 124, causing waste collection section 104 to form a generally cup-like device. As shown in FIG. 4 and FIG. 6, upon being manipulated in this manner, the collapsible bottom 130 forms a generally rectangular base 134, a first triangular flap 136 and a second triangular flap 138. As shown in FIG. 5 and FIG. 6, the first triangular flap 136 and the second triangular flap 138 may then be folded against the rectangular base 134, and the adhesive means activated to hold each flap against the rectangular base. The user may thereafter consume the food product 118 from the food product containing section 102 and dispose of any waste materials from the food product into the waste collection section 104, preventing such waste products from being improperly discarded. When finished the user may simply dispose of the waste collection section 104 along with its contents.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

1. A food package apparatus for containing a food product in a first section of the apparatus and a second section adapted to receive and retain waste from the food product, the food package apparatus comprising:
(a) a food product containing section comprising a first front panel and an opposite facing first back panel, the first front panel and the first back panel each bordered by a first peripheral edge, the first front panel and the first back panel attached together along the first peripheral edge, the food product containing section having a first compartment defined by the first front panel, the first back panel and the first peripheral edge, a portion of the first peripheral edge defining a top of the food containing section;
(b) a food product disposed in the first compartment;
(c) a waste collection section comprising a second front panel and an opposite facing second back panel, the second front panel and the second back panel each bordered by a second peripheral edge, the second front panel and the second back panel attached together along the second peripheral edge, the waste collection section having a second compartment defined by the second front panel, the second back panel and the second peripheral edge, a portion of the second peripheral edge defining a top of the waste collection section;
(d) a perforated attachment means for hingedly connecting the top of the food product containing section to the top of the waste collection section, wherein the food product containing section is detachable from the waste collection section; and
(e) the top of the food product section having a first access means to the first compartment and the top of the waste collection section having a second access means to the second compartment, said first access means and second access means operational when the food containing section is separated from the waste collection section.

2. The food package apparatus of claim 1 wherein the food product is sunflower seeds.

3. The food package apparatus of claim 1 wherein the food product is pistachios.

4. The food package apparatus of claim 1 wherein the first front panel, the second front panel, the first back panel, and the second back panel are rectangular.

5. The food package apparatus of claim 4 wherein the waste collection section has a collapsible bottom oppositely facing the top of the waste collection section, and opposite facing sides.

6. The food package apparatus of claim 5 where upon being collapsed, the collapsible bottom forms a generally rectangular base, a first triangular flap and a second triangular flap, wherein the first triangular flap and the second triangular flap may be folded against the base.

7. The food package apparatus of claim 6 wherein the first flap and the second flap comprise adhesive means for retaining the first triangular flap and the second triangular flap to the base.

8. The food package apparatus of claim 1 wherein the food package apparatus is manufactured from food grade packaging paper.

9. The food package apparatus of claim 8 wherein the food grade packaging paper has a wax coating.

10. A food package apparatus for containing a food product in a first section of the apparatus and a second section adapted to receive and retain waste from the food product, the food package apparatus comprising:
(a) a food product containing section comprising a first rectangular front panel and an opposite facing first rectangular back panel, the first rectangular front panel and the first rectangular back panel each bordered by a first peripheral edge, the first rectangular front panel and the first rectangular back panel attached together along the first peripheral edge, the food product containing section having a first compartment defined by the first rectangular front panel, the first rectangular back panel and the first peripheral edge, a portion of the first peripheral edge defining a top of the food containing section;
(b) a food product disposed in the first compartment;
(c) a waste collection section comprising a second rectangular front panel and an opposite facing second rectangular back panel, the second rectangular front panel and the second rectangular back panel each bordered by a second peripheral edge, the second rectangular front panel and the second rectangular back panel attached together along the second peripheral edge, the waste collection section having a second compartment defined by the second rectangular front panel, the second rectangular back panel and the second peripheral edge, a portion of the second peripheral edge defining a top of the waste collection section;
(d) a perforated attachment means for hingedly attaching the top of the food product containing section to the top of the waste collection section, wherein the food product containing section is detachable from the waste collection section; and
(e) the top of the food product section having a first access means to the first compartment and the top of the waste collection section having a second access means to the second compartment, said first access means and second access means operational when the food containing section is separated from the waste collection section.

11. The food package apparatus of claim 10 wherein the waste collection section has a collapsible bottom oppositely facing the top of the waste collection section, and opposite facing sides.

12. The food package apparatus of claim 11 where upon being collapsed, the collapsible bottom forms a generally rectangular base, a first triangular flap and a second triangular flap, wherein the first triangular flap and the second triangular flap may be folded against the base.

13. The food package apparatus of claim 12 wherein the first flap and the second flap comprise adhesive means for retaining the first triangular flap and the second triangular flap to the base.

14. The food package apparatus of claim 10 wherein the food package apparatus is manufactured from food grade packaging paper.

15. The food package apparatus of claim 13 wherein the food grade packaging paper has a wax coating.

16. The food package apparatus of claim 10 wherein the food product is sunflower seeds.

17. The food package apparatus of claim 10 wherein the food product is pistachios.

18. A food package apparatus for containing a food product in a first section of the apparatus and a second section adapted to receive and retain waste from the food product, the food package apparatus comprising:
(a) a food product containing section comprising a first rectangular front panel and an opposite facing first rectangular back panel, the first rectangular front panel and the first rectangular back panel each bordered by a first peripheral edge, the first rectangular front panel and the first rectangular back panel attached together along the first peripheral edge, the food product containing section having a first compartment defined by the first rectangular front panel, the first rectangular back panel and the first peripheral edge, a portion of the first peripheral edge defining a top of the food containing section;
(b) a food product disposed in the first compartment;
(c) a waste collection section comprising a second rectangular front panel and an opposite facing second rectangular back panel, the second rectangular front panel and the second rectangular back panel each bordered by a second peripheral edge, the second rectangular front panel and the second rectangular back panel attached together along the second peripheral edge, the waste collection section having a second compartment defined by the second rectangular front panel, the second rectangular back panel and the second peripheral edge, a portion of the second peripheral edge defining a top of the waste collection section, the waste collection section further comprising a collapsible bottom oppositely facing the top and opposite facing sides;
(d) a perforated attachment means for hingedly attaching the top of the food product containing section to the top of the waste collection section, wherein the food product containing section is detachable from the waste collection section; and
(e) the top of the food product section having a first access means to the first compartment and the top of the waste collection section having a second access means to the second compartment, said first access means and second access means operational when the food containing section is separated from the waste collection section.

19. The food package apparatus of claim 18 where upon being collapsed, the collapsible bottom forms a generally rectangular base, a first triangular flap and a second triangular flap, wherein the first triangular flap and the second triangular flap may be folded against the base.

20. The food package apparatus of claim 19 wherein the first flap and the second flap comprise adhesive means for retaining the first triangular flap and the second triangular flap to the base.
